(19) United States
(12) Patent Application Publication
(10) Pub. No.: US 2010/0179935 A1
(43) Pub. Date: Jul. 15, 2010

(54) SPIKING DYNAMICAL NEURAL NETWORK FOR PARALLEL PREDICTION OF MULTIPLE TEMPORAL EVENTS

(75) Inventors: NARAYAN SRINIVASA, Oak Park, CA (US); Youngkwan Cho, Los Angeles, CA (US); Leandro G. Barajas, Troy, MI (US)

Correspondence Address: MILLER IP GROUP, PLC;GENERAL MOTORS CORPORATION, 42690 WOODWARD AVENUE, SUITE 200, BLOOMFIELD HILLS, MI, 48304, US

(73) Assignee: GM GLOBAL TECHNOLOGY OPERATIONS, INC., Detroit, MI (US)

(21) Appl. No.: 12/353,031

(22) Filed: Jan. 13, 2009

(51) Int. Cl. G06N 3/08; G06F 15/18

(52) U.S. Cl. 706/21; 706/25

(57) ABSTRACT

A system and method for determining events in a system or process, such as predicting fault events. The method includes providing data from the process, pre-processing data and converting the data to one or more temporal spike trains having spike amplitudes and a spike train length. The spike trains are provided to a dynamical neural network operating as a liquid state machine that includes a plurality of neurons that analyze the spike trains. The dynamical neural network is trained by known data to identify events in the spike train, where the dynamical neural network then analyzes new data to identify events. Signals from the dynamical neural network are then provided to a readout network that decodes the states and predicts the future events.

### BACKGROUND OF THE INVENTION

1. Field of the Invention

This invention relates generally to a system and method for determining events in a system or process and, more particularly, to a system and method for predicting multiple faults in a system or process using a liquid state machine approach.

2. Discussion of the Related Art

Various types of systems, such as manufacturing processes, can employ many different machines operating in a variety of different manners. For some of these systems, it is critical that the system operate efficiently without interruption because failure of any part of the system may cause the whole system to go down, which could be costly. Because of this, there has been great effort in various industries to monitor certain systems in an attempt to predict failures and faults that may be more effectively handled prior to the failure actually occurring. For example, it is known to monitor various detectors and sensors in a system in an attempt to predict a failure of the detection or sensor before it occurs. However, given the vast number of inputs for such systems, little success in predicting faults and failures has been achieved.

Traditional approaches to fault prediction are capable of processing only single and possibly uncorrelated fault types. When these approaches are used for processing more than one fault, they tend to provide less robust results because of the cross-talk between various faults impinging on the network nodes. The fundamental reason for this is that the training regime used is typically based on back-propagating weight changes in the network that is very susceptible to being trapped in a local minima. In those systems that predict different faults independently, such processes do not exploit correlations and are too expensive to be used to cross entire data sets. In those processes that predict faults using correlating models, the execution time of the process grows either exponentially or geometrically, and it is only feasible if the number of faults to predict is low and there is a known correlation.

Fault occurrences in these types of system are typically noisy and have a variable rate. Also, the fault occurrences have complex, non-linear dynamics and need to be uncovered for a robust prediction.

### SUMMARY OF THE INVENTION

In accordance with the teachings of the present invention, a system and method are disclosed for determining events in a system or process, such as predicting fault events. The method includes providing data from the process, pre-processing the data and converting the data to one or more temporal spike trains having spike amplitudes and a spike train length. The spike trains are provided to a dynamical neural network operating as a liquid state machine that includes a plurality of neurons that analyze the spike trains. The dynamical neural network is trained by known data to identify events in the spike train, where the dynamical neural network then analyzes new data to identify events. Signals from the dynamical neural network are then provided to a readout network that decodes the states and predicts the future events.

Additional features of the present invention will become apparent from the following description and appended claims, taken in conjunction with the accompanying drawings.

### BRIEF DESCRIPTION OF THE DRAWINGS

FIG. 1 is a conceptual illustration of a liquid state machine;

FIG. 2 is a plan view of a system for predicting temporal events using a liquid state machine;

FIG. 3 is an illustration of a sample data sequence and the resulting spike train for class-based encoding and data-based encoding that can be employed in the system shown in FIG. 2; and

FIG. 4 is a plan view of a system for providing multiple temporal events using a neural network and a liquid state machine concept.

### DETAILED DESCRIPTION OF THE EMBODIMENTS

The following discussion of the embodiments of the invention directed to a system and method for predicting multiple temporal events using a neural network and liquid state machine design is merely exemplary in nature, and is in no way intended to limit the invention or its applications or uses.

The present invention proposes a system and method for simultaneously predicting future occurrences of multiple fault events in a system or process, such as a production line or a manufacturing plant. The proposed approach derives its roots from spike train based neural networks and is robust and efficient in its predictions despite simultaneously modeling of several faults. One example of a spike rain based neural network is a liquid state machine (LSM) that uses an excitable medium, i.e., a liquid, to process temporal inputs in real-time, and simple read out units to extract temporal features in the medium and produce an estimation. While a traditional computation model relies on discreet states, such as 0/1 or on/off, that remain stable, the LSM uses continuous and transient states. LSM functions resemble a body of liquid and the inputs disturb the surface of the liquid to create unique ripples that propagate, interact and eventually fade away.

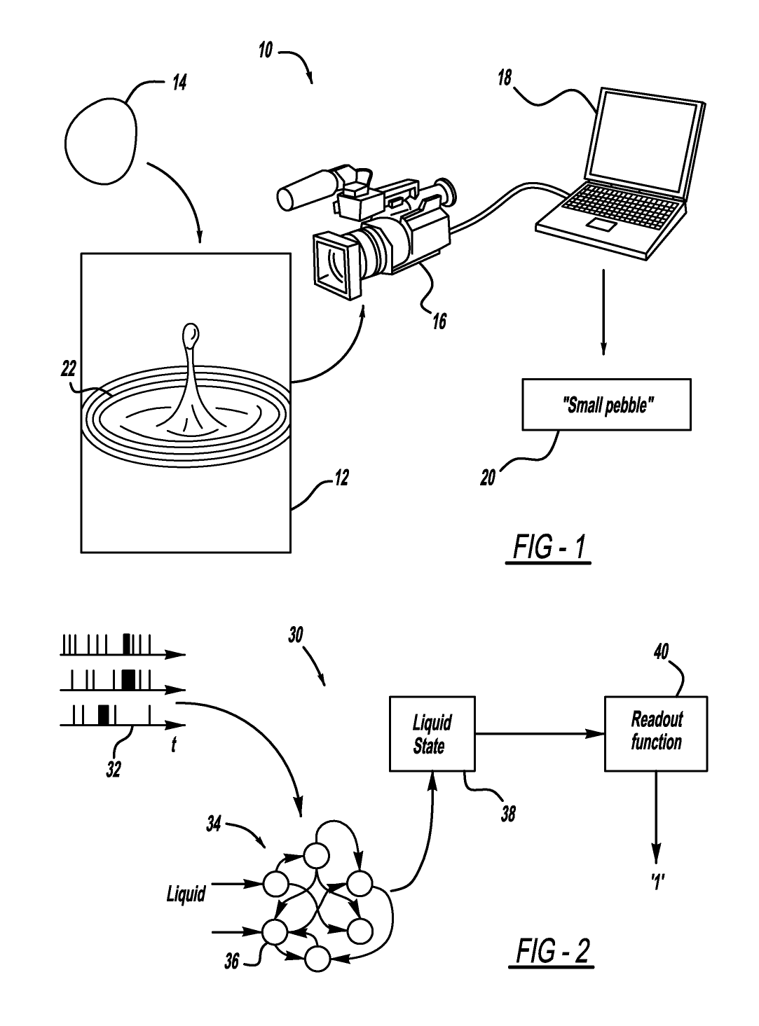

FIG. 1 is a plan view of a system 10 representing a liquid state machine. The system 10 includes a liquid 12 that receives an input 14, in this case a pebble. The pebble 14 creates ripples 22 on the surface of the liquid 12 that are observed and recorded by a camera 16. Recorded images from the camera 16 are then sent to a computation device 18 that analyzes the ripples 22 in the images. After several events occur of the pebble 14, or other pebbles, falling into the liquid 12, the computation device 18 learns how to read the liquids surface, i.e., the LSM states, so that valuable information can be extracted about other inputs to the liquid 12 without having to do a complex input integration. The current state of the LSM is a function of time-varying inputs and time. This idea has been proposed as a way to gain insights on how the brain could process temporal inputs in the cerebral cortex.

The present invention exploits the basic frame work of dynamical neural networks, such as liquid state machines. Because the state of the dynamical neural network is a function of its past inputs, it is proposed that it is possible to exploit these dynamical states as a window into past events and use that information to predict or classify an impending occurrence on a future event. Furthermore, the state of the dynamical system is independent of the source from which the input was derived. Because the liquid medium of the dynamical neural network adjusts its state automatically as input events impinge upon it, a single dynamical neural network can also accept a multiple series of input events. Thus, a single dynamical neural network can be used to process multiple faults simultaneously.

The present invention formulates the fault problem as a spike train based dynamic neural network. Particularly, the state of the dynamic neural network layer, composed of excitatory and inhibitory neurons, is changed due to inputs in the form of spike trains. An excitatory neuron adds signal strength to the neurons it is connected to and an inhibitory neuron attenuates signals. In one non-limiting embodiment, the neural network includes 80% excitatory neurons and 20% inhibitory neurons.

The dynamically changing state of a network layer provides an image of the network state. This image can be of a snapshot of the network at a given time and is dependent on the history of the past spikes that impinged on the network. This image is a non-linear transformation of the input space. By training a simple one layer network on top of this dynamic network layer, it is possible to simultaneously classify and predict multiple faults at the same time in a very robust fashion.

The basic operation for processing multiple faults using dynamic neural networks is given as follows. First, the raw fault event data is preprocessed by sorting the raw fault events by fault-code and time. The events are then resampled and classified. The process then selects a spike train encoding scheme to encode temporal occurrences of faults, and determines an appropriate length of an event window, referred to as a spike length. The process then generates a dynamical neural network, including generating a train set and test set of spike trains. The readouts are then trained by applying a semi-supervised learning algorithm to the trained data set, and the performance of the trained readouts on the test set data are predicted and evaluated.

FIG. 2 is a plan view of a dynamical neural network for parallel prediction of multiple temporal events. The network 30 receives a set of spike train inputs 32 that correspond to multiple events from a single operation of the type discussed above, and further discussed below. The spike train set 32 is applied to a neural network 34 including interconnected neurons 36 that operate as a single LSM. The application of a spike train set 32 to the network 34 causes the network 34 to go into a liquid state 38. The sequence of spatial inputs provided by the spike train set 32 causes the network 34 to learn a sequence of events for a particular machine and a class that the machine belongs to build a model of the operation of that machine, and does it for multiple machines. After the network 34 is trained, then actual data can be used as the spike train input to the network 34, which will cause the network 34 to provide the liquid state 38 that could identify an upcoming fault or other event. The liquid state 38 is read at box 40 which provides an output of the predicted future events.

The data from the various machines, detectors, sensors, etc. that is encoded to generate the spike train set 32 can be performed in any suitable technique. For example, a space encoding technique can be employed where data classes can be encoded with two binary digits. For example, for a four class problem, class 0 is encoded 00, class 1 is encoded 01, class 2 is encoded 10 and class 3 is encoded 11. The input events are encoded into two spike trains, a high digit train and a low digit train, and fed into the LSM with two input lines.

Also, a frequency-based encoding scheme can be employed where all of the spikes have the same magnitude. A weak stimulus is represented with a low frequency, i.e., a few spikes at a time interval, and a strong stimulus is represented with high frequency, more spikes in the time interval.

Further, a class-based encoding scheme can be employed where the number of spikes in the corresponding interval in the spike train is decided based on the class that the event belongs to. The class to which each event belongs can be decided by several standard means including among others any variation of data, model or expert-driven clustering. An event in class 1 is encoded into one spike in the corresponding interval, an event in class 2 is encoded into two spikes in the corresponding interval, an event in class 3 is encoded into three spikes in the corresponding interval, etc.

Also, data-based encoding can be employed that maps the actual data, such as down time or frequency, of the event into the number of spikes from one spike to N spikes. For the mapping or scaling function, a square root function can be initially used, and later a log function can be used.

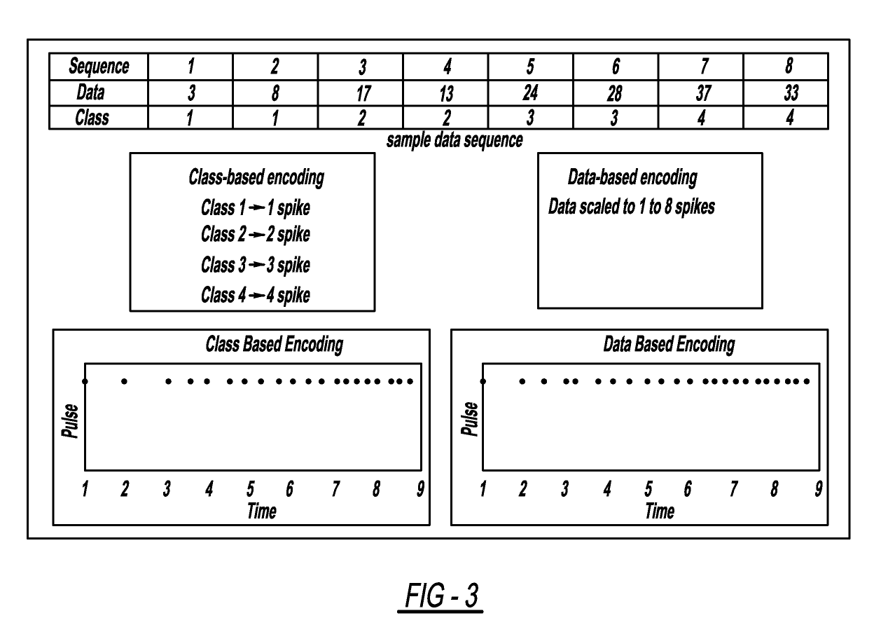

FIG. 3 is an illustration showing a sample data sequence and the resulting spike train for class-based encoding and data-based encoding discussed above. The sequence member, data and class numbers are given at the top of the illustration for a sample data sequence. For class-based encoding, class 1 is one spike, class 2 is two spikes, etc. A spike train for the class-based encoding is shown by the graph on the left where each pulse represents a spike. For the data-based encoding, the data is scaled from one to N spikes. A spike train for the data-based encoding is shown by the graph on the right where the pulses represent the spikes.

The dynamical neural network has many adjustable parameters that will affect the performance and execution time of various applications. The neurons in the dynamical neural network have a refractory period where the neurons require time to recover after processing. In one embodiment, the interval for each event can be set to 25 ms and the refractory period can be set to 3 ms. Thus, each event interval can accept up to eight effective spikes. Among the various other parameters, the number of neurons and the ratio of excitatory to inhibitory neurons in the network are important. In one embodiment, 256 neurons can be employed and a 0.85 ratio of excitatory to inhibitory neurons can be used. Class accuracy is determined as the number of correct predictions divided by the number of test cases. The length of a spike train affects the performance of the system. Several variations of the spike train lengths can be tried. Each fault has different characteristics and shows peak performance on different spike train lengths. Thus, for this embodiment, there is no single optimal spike train length. It has to be estimated on a fault-by-fault or group-by-group basis.

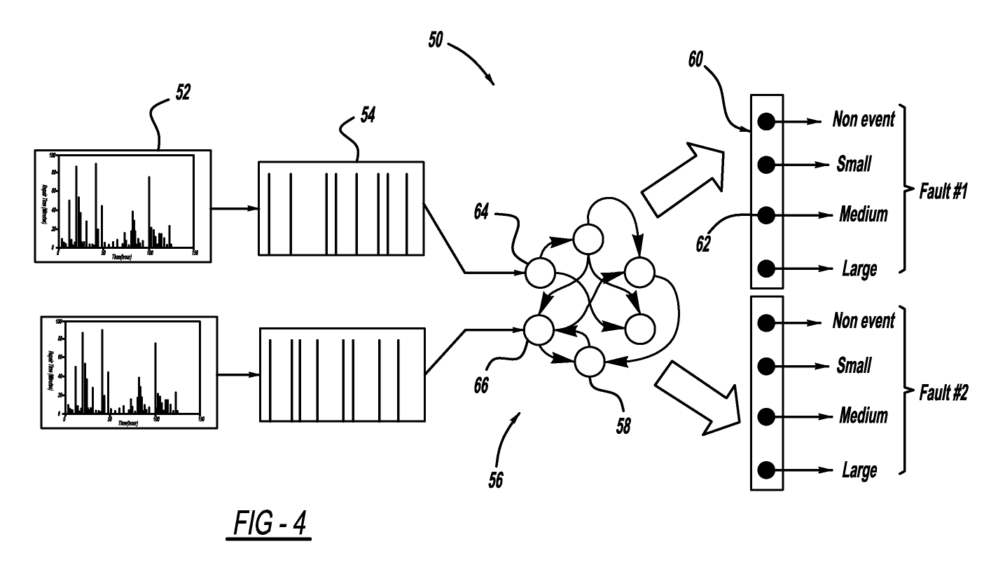

FIG. 4 is a prediction system 50 of the type discussed above that uses data for a particular operation to teach a dynamical neural network, and then uses that teaching to determine whether a fault or other event may occur in the future. The system 50 is able to determine multiple faults simultaneously. In this embodiment, data is input into the system 50 as two separate data streams. The fault data is characterized by any suitable format for the purposes described herein over time, and provided as data input 52 to the system 50. The data input 52 is then converted into a spike train 54 including spikes using any of the various encoding techniques discussed above, such as space encoding, frequency-based encoding, class-based encoding and data-based encoding. The spike trains 54 are then input into a neural network 56 including neurons 58 having input neurons 64 and 66. The neurons interact as discussed above to provide readout data to display devices 60 having indicators 62 for different faults. In this non-limiting embodiment, the faults are identified as a non event, a small event, a medium event or a large event. The four outputs of each display device 60 correspond to the four classes of events to be classified.

Each readout monitors the dynamical network states and generates its estimation. A class that corresponds to a readout with a highest value is chosen as the predicted class. Machines are seldom down in a manufacturing plant, and they are rarely down for a long time. This implies that the data distribution for the various classes is different. The number of events in a no event class is very large and the number of events in a large class is very small. There is a large bias in the data set. In one embodiment, the number of cases in each class is counted, and the minimum number is determined. The minimum number is usually small. It is not appropriate to select the same minimum number of classes from all of the classes because that may abandon lots of useful data in other classes. Based on the minimum number, the maximum number of cases that will be included in the spike train data set for all classes are set. When the number of cases in the class is larger than the maximum, only a select number of selected cases are included. Some of the neurons 58 are selected as input neurons that receive the spike train data. Depending on which of the other neurons 58 the input neurons are connected to will determine which neurons are fired. For example, when the input neurons 64 and 66 receive a spike from the spike trains 54, they will send those spikes to the neurons 58 that they are coupled to. If a neuron gets enough spikes from other neurons that combination of the spike exceeds a threshold, then that neuron will fire and provide a spike to the neuron it is coupled to. Every one of the neurons 58 in the network 56 is coupled to each of the readout neurons 62.

The system 50 shows that the algorithm scales linearly in computation time with an increase in the number of faults. Normally for this kind of problem, the computation time increases exponentially given the event cross-correlation. The algorithm also shows that the false alarms can be decreased when the LSM is exposed to more fault data from the same operation while accuracy can be increased. Also, by simultaneously processing multiple faults, the LSM is able to improve by reducing the false alarms on faults as more faults are modeled because it is able to extract new correlations with more faults thereby improving its ability to make accurate predictions.

LSM is approximately linear in computation time in respect to the number of input variables. The event detection accuracy of the LSM is not significantly affected when the number of faults processed increases. Further, the false alarm rate of the LSM remains relatively low and constant when the number of faults processed increases. Also the LSM is a feasible alternative for heterogeneous multi-variable prediction. Heterogeneous variables are, for example, combinations of discrete/continuous data, periodic/aperiodic signals and symbolic/numeric qualifier/quantifiers.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A method for determining temporal events, said method comprising:
providing data from a particular process;
converting the data to a temporal spike train having spike amplitudes and a spike train length;
training a dynamical neural network including a plurality of neurons to identify events;
providing the spike train to the trained dynamical neural network to analyze the spike train and predict events in the spike train; and
providing signals from the dynamical neural network to a readout device that identifies whether an event may occur.

2. The method according to claim 1 wherein converting the data to a spike train includes employing a class-based encoding scheme.

3. The method according to claim 1 wherein converting the data to a spike train includes employing a data-based encoding scheme.

4. The method according to claim 1 wherein converting the data to a spike train includes employing a space encoding scheme.

5. The method according to claim 1 wherein converting the data to a spike train includes employing a frequency-based encoding scheme.

6. The method according to claim 1 wherein the dynamical neural network operates as a liquid state machine.

7. The method according to claim 1 wherein the plurality of neurons include excitatory neurons and inhibitory neurons.

8. The method according to claim 7 wherein the ratio of excitatory neurons to inhibitory neurons is about 20% excitatory neurons and about 80% inhibitory neurons.

9. The method according to claim 1 wherein the method provides a parallel prediction of multiple temporal events simultaneously from a plurality of input spike trains.

10. The method according to claim 1 wherein the dynamical neural network is trained using a semi-supervised learning process.

11. The method according to claim 1 further comprising processing the data including sorting the data and classifying the data.

12. The method according to claim 1 wherein the method provides a prediction of temporal faults in a manufacturing process.

13. A method for providing a parallel prediction of multiple temporal fault events in a manufacturing process, said method comprising:
providing data from a particular process;
pre-processing the data to sort and classify the data;
converting the data to a plurality of temporal spike trains each having spike amplitudes and a spike train length;
training a dynamical neural network operating as a liquid state machine including a plurality of neurons to recognize fault events using a supervisory learning process;
providing the spike trains to the dynamical neural network to analyze the spike trains and predict fault events in the spike trains; and
providing signals from the dynamic neural network to a readout device that identifies whether a fault event may occur.

14. The method according to claim 13 wherein converting the data to a plurality of spike trains includes employing an encoding scheme from the group consisting of space encoding, frequency-based encoding, class-based encoding and data-based encoding.

15. The method according to claim 13 wherein the plurality of neurons include excitatory neurons and inhibitory neurons.

16. The method according to claim 15 wherein the ratio of excitatory neurons to inhibitory neurons is about 20% excitatory neurons and about 80% inhibitory neurons.

17. A method for providing a parallel prediction of multiple temporal fault events in a manufacturing process, said method comprising:
providing data from a particular process;
converting the data to a plurality of temporal spike trains each having spike amplitudes and a spike train length;
training a dynamical neural network operating as a liquid state machine including a plurality of neurons to recognize fault events; and
providing the spike trains to the dynamical neural network to analyze the spike trains and predict fault events in the spike trains.

18. The method according to claim 17 wherein converting the data to a plurality of spike trains includes employing an encoding scheme from the group consisting of space encoding, frequency-based encoding, class-based encoding and data-based encoding.

19. The method according to claim 17 wherein the plurality of neurons include excitatory neurons and inhibitory neurons.

20. The method according to claim 17 wherein the dynamical neural network is trained using a semi-supervised learning process.
